(19) United States
(12) Patent Application Publication
(10) Pub. No.: US 2020/0118223 A1
(43) Pub. Date: Apr. 16, 2020

(54) USING ARTIFICIAL INTELLIGENCE TO PROCESS DATA EXTRACTED FROM UTILITY BILLS

(71) Applicant: PEAR.AI, San Francisco, CA (US)

(72) Inventors: Sukhjinder SINGH, Orinda, CA (US); Peter Shiao-Heng Shiau, San Francisco, CA (US); John Michael Garris, San Francisco, CA (US); Mark Eugene Feichtner, Spokane, WA (US)

(21) Appl. No.: 16/216,667

(22) Filed: Dec. 11, 2018

Related U.S. Application Data
(60) Provisional application No. 62/745,062, filed on Oct. 12, 2018.

(51) Int. Cl. G06Q 50/06; G06F 17/21; G06F 17/27; G10L 15/18; G10L 17/22

(52) U.S. Cl. CPC G06Q 50/06; G06F 17/218; G10L 17/22; G10L 15/1822; G06F 17/2705

(57) ABSTRACT

Using artificial intelligence to automatically and intelligently extract critical data from utility bills, enrich the extracted data with other data, categorize the data, validate and detect anomalies in the data, draw insights from the data, and pro actively present usage recommendations based on the insights and respond to user inquiries regarding the data through a user-friendly interface.

### CROSS-REFERENCE TO RELATED APPLICATIONS

This application claims priority of U.S. Provisional Application No. 62/745,062, entitled “Using Artificial Intelligence to Process Data Extracted From Utility Bills” filed on Oct. 12, 2018, which is incorporated herein by reference in its entirety for all purposes.

### FIELD OF THE INVENTION

The present application is directed to a system and method for extracting data from utility bills, enrich the extracted data with third party and/or meat data, applying artificial intelligence to the data for the purposes of detecting utility usage anomalies, analyzing and drawing insights into the usage of the utility, providing a natural language interface for users to ask questions and receive responses regarding their utility usage, and offer utility related consulting services, including pro-actively providing recommendations regarding utility usage, cost-saving measures, possible equipment repair and/or replacement, peak shaving, purchasing the utility in a derogated market, etc.

### DESCRIPTION OF RELATED ART

The utility industry, whether electric, gas, water, etc., provides critical services to individuals and corporate entities alike. Without these utilities, modern life as we now enjoy it would be next to impossible.

The utility industry, while providing essential services, to a large degree has not kept pace with many of the recent advancements in data processing and artificial intelligence. As a result, when it comes to generating, processing and the payment of utility bills, little has changed in decades. Most utilities generate and send invoices to customers for a fixed billing cycle (i.e., from a given day of one month to the same day of the next month) detailing the amount of the utility consumed, the charge rate or rates of the utility, the amount due, and possibly some historical information showing past usage in previous cycles. Other than providing consumers the ability to access and pay their utility bills on line, utility companies offer little other information or intelligence derived from processing utility usage data.

Most individual consumers “blindly” pay their utility bill, having little understanding of what they are paying for or if they are being over-charged. For example with electrical bills, most consumers will have no idea if the kilo Watt hours (kw) listed in the bill is accurate or not, their peak usage, the accuracy of the rate they are being charged for peak and off-peak consumption, if they are entitled to rebates, etc. As a result, most consumers have no idea if the amount due is correct or not. In most cases, the amount is simply paid in order to avoid late charges. Even in circumstances where a consumer realizes that he/she is being over-charged, they often do nothing about it because dealing with the bureaucracy of a large, often monopolistic, utility is more trouble than it is worth.

With larger entities with multiple properties, such as corporations, businesses, government agencies, or charitable organizations, the issues in dealing with and paying utility bills is further complicated. If the multiple properties are in different geographic locations, each property will typically have to deal with a different local utility company, each having different billing cycles, rates, tariffs, taxes and regulations, etc. As a result, sorting through and trying to develop insights into the usage of a given utility across the different properties of an organization is extremely challenging.

By way of example, the Applicant has studied a well-known national supermarket chain having well over 400 stores across the United States. Between lighting, heating, air conditioning, refrigeration, and running equipment, the amount of electricity consumed by each market is enormous, typically costing well into the high five-figure range per store each month. The total expenditures for this supermarket chain, across all of its stores, warehouses, offices, etc., is in the range of millions and millions of dollars per year.

Large organizations with multiple properties in diverse locations, such as such as the above-referred to supermarket chain, have a difficult time understanding their energy usage or figuring out insights that could potentially be used to reduce consumption and save money. With stores located in either different states and/or different locations in the same state, such organizations typically have to deal with numerous of local utility providers. Each utility provider will typically have different billing cycle dates, have different peak and off peak rates, charge different fees, taxes or tariffs per local regulations, etc. In addition, a given property may have multiple meters, each having a different billing cycle. In some markets (called “derogated markets”), customers may need to aggregate billing data from more than one bill to correctly understand the costs and usage for utility usage (such as electricity) for a single meter. To make matters even more complicated, exterior factors such as varying weather or climate differences, different regulations, tariffs, taxes that may vary from location to location, may also significantly affect consumption and costs. As a result, the utilities bills for such organizations tends to be a nebulous morass.

There are few tools available today to help both organizations and/or home owners to check on the veracity of utility bills or gain insights on how consumption can be reduced and money saved. With no tools currently available to sort all the data and draw some insights among the multiple properties, most utility bills are simply paid, regardless if they are accurate or not.

In the energy industry, it is known to use energy consultants to help large entities to get a grasp on their energy usage. These consultants will typically manually sort through monthly energy bills, enter the data into a spreadsheet, process the data, and then present the data to their clients in the form of static, and often complicated, charts. A sophisticated energy manager is still required to make sense of all the data.

A system and method for using artificial intelligence to analyze utility data, provide useful insights, and which is accessible via a user-friendly interface is therefore needed.

### SUMMARY

The present application is directed to a system and method for using artificial intelligence to analyze utility bill data. In non-exclusive embodiments, the system and method involves extracting data from utility bills, enrich the extracted data with canonical and/or meat data, applying artificial intelligence to the data for customer purposes of detecting utility usage anomalies, analyzing and drawing insights into the usage of the utility, providing a natural language interface for users to ask questions and receive responses regarding their utility usage, and offer utility related consulting services using the insights and analysis derived from applying the artificial intelligence to the data. Such consulting services may include pro-actively providing recommendations regarding utility usage, cost-saving measures, possible equipment repair and/or replacement, peak shaving, purchasing the utility in a derogated market, etc.

In non-exclusive embodiments, a virtual account is created for the utility meters associated with the system respectively. Each virtual account includes a number of attributes associated with its corresponding meter, such as but not limited to, a meter identifier (ID), a service agreement ID, a service account ID, at least one bill-block, one or more average daily usage values and/or canonical data.

The virtual accounts are derived from data extracted from the utility bills associated with each meter respectively. By breaking utility consumption and other billing components down to basic units of consumption, such as bill-blocks and daily usage values, much of the nebulous morass of dealing with inconsistent utility bills, each having different billing cycles, formats, billing rates, taxes tariffs, etc., is avoided. As a result, artificial intelligence can readily be used to analyze the utility usage data, derive insights, responding to natural language queries and generating utility usage recommendations in ways previously not possible. Furthermore, the virtual account concept is used to accommodate many data quality issues that appear on utility bills, such as missing meter IDs or account identifiers, or changes in meter IDs that appear on bills with no associated explanation.

In yet other embodiments, the system and method can be applied to any type of utility, including but not limited to, electric, gas, water, sewer, etc.

### BRIEF DESCRIPTION OF THE DRAWINGS

The present application and the advantages thereof, may best be understood by reference to the following description taken in conjunction with the accompanying drawings in which:

FIG. 1 is a block diagram of an automated platform for applying artificial intelligence to data extracted from utility bills and to provide insights, recommendations and response to inquiries to users via a user-friendly interface in accordance with the present invention.

FIG. 2A is a diagram illustrating how data is extracted from utility bills, enhanced, categorized, validated and stored in an energy data store in accordance with the present invention.

FIG. 2B is diagram illustrating the creation of an exemplary virtual account for a meter in accordance with a non-exclusive embodiment of the present invention.

FIG. 3 is a flow diagram illustrating steps for pushing data into analytical data store and responding to user inquiries in accordance with a non-exclusive embodiment of the present invention.

FIG. 4 is a flow diagram illustrating the use of artificial intelligence to analyze utility bills and provide anomaly detection, notify users of insights and provide energy related recommendations.

In the drawings, like reference numerals are sometimes used to designate like structural elements. It should also be appreciated that the depictions in the figures are diagrammatic and not necessarily to scale.

### DETAILED DESCRIPTION

The present application will now be described in detail with reference to a few non-exclusive embodiments thereof as illustrated in the accompanying drawings. In the following description, numerous specific details are set forth in order to provide a thorough understanding of the present disclosure. It will be apparent, however, to one skilled in the art, that the present discloser may be practiced without some or all of these specific details. In other instances, well known process steps and/or structures have not been described in detail in order to not unnecessarily obscure the present disclosure.

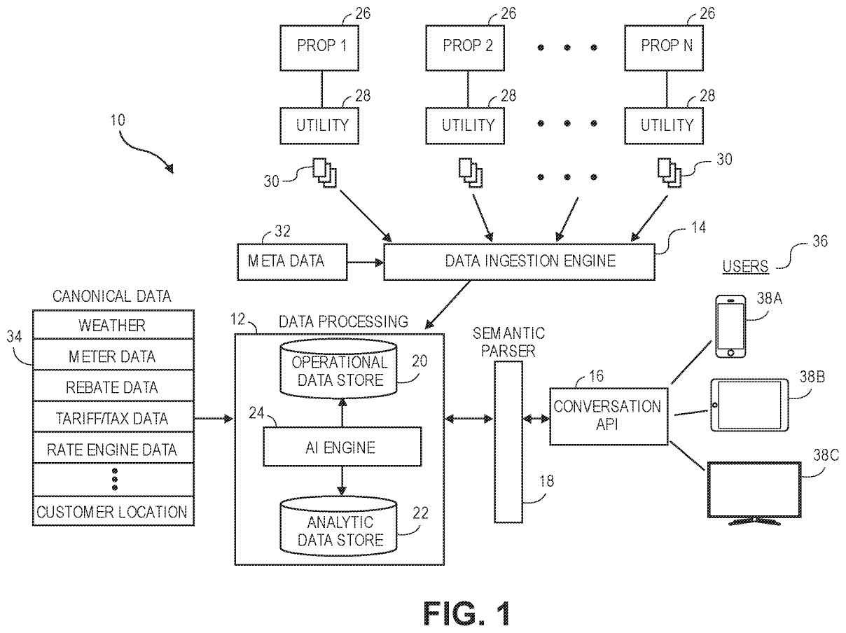

Referring to FIG. 1, a block diagram of an automated platform 10 for applying artificial intelligence to utility usage data is shown. The automated platform 10 includes a data processing center 12, a data ingestion engine 14, a conversation Application Programming Interface (APE) 16, and a semantic parser 18. The data processing center 12 further includes an operational data store 20, an analytic data store 22, and an Artificial Intelligence (AID) engine 24.

In different embodiments, the data processing center 12 may be implemented by a single server, multiple servers, one or more server clusters, one or more server farms, or any combination thereof. In yet other embodiments, the data processing center 12 may be a single data processing center or may be a distributed data processing center having a number of data processing facilities interconnected over a network.

For the sake of simplicity, operation of the data processing center 12 as provided below is described in relation to electric utility bills for a single customer having multiple managed properties. It should be understood that the data processing center 12 can service (1) a plurality of customers, (2) each of the plurality of customers having either a single or multiple properties and (3) other types of utilities, such as gas, water, sewer, etc. The discussion below is therefore merely exemplary and in no way should be construed as limiting.

In an illustrative example, a single customer serviced by the data processing center 12 has multiple properties 26 (labeled Prop 1, Prop 2, . . . Prop N). Each of the properties may include a single building or a group of buildings located in close proximity, such as found on a campus. Each property may be served by one or more electric meters. For example, a given property 26 may be a single office building having a single meter or several meters (i.e., one for each tenet), an apartment building with one meter or multiple meters (i.e., one for each apartment), or several buildings, each with their own meters.

The various properties (Prop 1, Prop 2, . . . Prop N) may also be located in close or far away geographic locations. For example if the customer is a large supermarket chain, a national fast food chain, a national department store chain, a national bank, then the customer will typically have multiple properties in diverse geographic locations, such as throughout multiple states and/or in multiple towns, cities and/or counties in a given state, or even in multiple countries.

For each property 26, an electricity bill from a local utility 28 is received. The bills can be received at each property, by a property manager, by an out sourced bill payment company, etc. For the various managed properties 26, the local 28 utility can be the same or different. Each property periodically receives a utility bill 30 from the local utility 28 for its electricity usage during a predefined period of time (e.g., every 30 days, monthly, quarterly, etc.). As a general rule, electricity bills invoice customers based on a combination of (1) the amount of electricity consumed, (2) the time of day the electricity was consumed (i.e., peak rates are more expensive than non-peak rates), and (3) various taxes, tariffs, and fees. In various embodiments, the utility bills 30 may be received in a number of different formats, including paper or hard copies, PD. Files, and/or structured data feeds.

The format of electric utility bills 30 from different utilities 28 tend to widely vary. Each bill 30 may have different billing cycle dates, charge different rates, and/or apply different tariffs, taxes or fees, including charges based on usage. In addition, a given bill 30 may include charges for a single meter or multiple meters if present on a given property 26. Alternatively, if a given property 26 has multiple meters, then a bill 30 may be received for each meter respectively. In addition, a given property 26 may have different accounts. Depending on the utility, a customer may receive separate bills for each account, or one consolidated bill for all the accounts. These are just a few examples demonstrating why utility bills 30, from property 26 to property 26, tend to be highly inconsistent. As a result, there is typically no clear relationship between (1) between electric utility bills from one property 26 to the next and/or (2) the billing amount and the metered amount of electricity usage.

The data ingestion engine 14 is arranged to extract meter and other key data from the often highly irregular bills 30 and organize the extracted data into a consistent structured format. In other words, the meter data is essentially de-coupled from the other information contained in each bill 30. As a result, meter and other data extracted from the bills 30 from multiple utility providers 28 is organized into a consistent format that can be used for reporting and analysis.

By extracting data specific to the meter(s) from bills 30, a number of benefits may be realized, including (1) providing a standardized way to categorized charges and usage values, (2) providing the ability to set up “virtual accounts” that unify, into a consistent format, the many different and varying ways utility companies invoice customers, (3) simplifies the task of identifying anomalies in the bills 30 (4) facilities the ability to apply artificial intelligence to the extracted data, which in turn, that can be used to analyze and define insights into the energy consumption by customers and (5) matching the supply and distribution of energy. A distributor is the company or organization that supplies the energy to the property 26 (i.e., owns or controls the power lines, substations, etc.). The supplier is the energy service provider that charges for the usage of the electricity. In a derogated energy market, the supplier of the energy and the distributor of the electricity are not necessarily the same. While the distributor for a given property is typically fixed, the purchaser of the electricity may select among different suppliers.

The data ingestion engine 14 is also responsible for assigning meat data 32 to the meters and other data extracted from the utility bills 30. Such meat data 32 may include, for example, the location of each meter, the type of property the meter is provided at (e.g., office space, retail, apartment, restaurant, warehouse, etc.), the square footage of the metered property, store hours, building specific information like having a parking garage, equipment installed (coolers, HACK, heat-pumps, solar, energy generation or storage equipment). Once the meter, meat data 32 and other data is organized and placed into the consistent structured format, it is written into the operational data store 20 of the data processing center 12.

In an optional embodiment, canonical data 34 may also be overlaid or otherwise associated with the extracted metered, meat and other data maintained in the operational data store 20. Such canonical data, which typically has been reformatted to be compatible with the formatted data maintained in the operational data store 20, may include for each meter (1) local weather data, (2) meter data such as the model number, manufacturer, accuracy information, etc. (3) any applicable local rebate data, (4) applicable tariffs, taxes and other government fees, (5) rate engine data, which is data generated by a rate engine that generates information regarding different rate plans, rates for peak and off peak hours, rates offered by different suppliers in a derogated market, etc. With this rate engine data, recommendations can be made based on a user's energy usage and energy usage patterns, and (6) customer location data, etc. It should be understood that this list of canonical data is merely illustrative and is not exhaustive. A wide variety of other types of canonical data may also be used.

The Artificial Intelligence or “AID” engine 24 processes the data collected and maintained in the operational data store 20 and stores the processed results in the analytic data store 22. The AID engine 24 can be programmed to process and compute a wide variety of useful information: For example:
The AID engine 24 can be used to identify anomalies in the bills 30 of the customer. For example, a first bill for a meter may detail usages charges from the first to the last day of a month. The next bill for the same meter defines a billing cycle starting from the 25th day of the previous month to the 25th day of the current month. The customer is therefore being double-charged for the overlapping days.
The AID engine 24 can be used to detect the inappropriate charge of late fees.
The AID engine 24 can be used to detect “instrument” changes. For example, the AID engine 24 can be configured to detect if a conventional meter has been swapped out by the utility to a “smart” meter.
The AID engine 24 can be used to track and detect significant changes in energy usage. If the amount of energy usage detected by a meter is suddenly up or down above or below a threshold, the customer can be notified.
The AID engine 24 can be used to analyze and provide insights into energy consumption. Such insights may include proposing to the customer that they may benefit from using a different rate plan, proposing to the customer that certain capital expenditure, such as investing in solar or purchasing more efficient equipment may be beneficial, detecting equipment issues or failures based on energy consumption, etc.
Map energy usage to the various properties 26 (e.g., Prop 1 through Prop N) respectively.

In a non-exclusive embodiment, the data maintained in the analytic data store 22 is denaturalized. As is well understood, certain portions of the data maintained in the analytic data store 22 is intentionally reproduced in order to improve read performance. For instance, certain attributes of the data maintained in a table or other data structures, or the tables or data structures themselves, can all be made redundant, with the objective of making the data more accessible and decreasing read times during queries.

In another non-exclusive embodiment, the conversation APE 16 and the semantic parser 18 are responsible for implementing a user-friendly natural voice interface that allows users 36 to ask the data processing center 12 questions and receive intelligent replies. With this arrangement, the communication APE 16 defines a set of subroutine definitions suitable for converting received analog voice signals into natural language “utterances” in electronic form. The semantic parser 18 is responsible for converting the utterances into a machine-understandable representation of their meaning that is decipherable by the data processing center 12. With this arrangement, users 36 with devices, such as smart phones 38A, tablet computes 38B, and/or desktop or laptop computers 38C, can make natural language voice inquiries to the data processing center 12. In response, the data processing center 12 provides a natural language response.

In various embodiments, users 36 can be individuals, a home owner or property manager, an energy manager for an organization, or any other party interested in or responsible overseeing the energy consumption of one or more of the properties 26.

Table I below provides several examples of natural language conversations that may take place between a user 36 and the data processing center 12.

TABLE I

| User Inquiry | Semantic Structure | Platform 10 Response |
|---|---|---|
| “What was my energy | Intent: get_usage | Get usage result: |
| usage last month at the | Time period: | 14,236 kWh |
| Palladio Parkway | Jul. 1, 2018-Jul. 31, 2018 | Web UI (voice) |
| facility?” | Location: Pallado | Response: “Your |
| | Parkway | usage last month at |
| | Channel: Web UI | Palladio Parkway |
| | | was 14,236 kWh.” |
| “What is my year-to-date | Intent: Get_usage | Get usage result: |
| energy usage in Arizona?” | Time period: | 289,453 kWh |
| | Jan. 1, 2018-Aug, 28, 2018 | Web UI (voice) |
| | Location: Arizona | Response: “Your |
| | Channel: Web UI | year-to-date |
| | | electricity usage in |
| | | Arizona is 289,453 kWh.” |
| “What was my energy | Intent: Get_usage | Get usage result: |
| usage last year in my | Time period: | 2,276,416 kWh. |
| warehouses” | Jan. 1, 2017-Dec. 31, 2017 | Web UI (voice) |
| | Building type: | Response: “Your |
| | warehouses | total electricity |
| | Channel Web IU | usage in your |
| | | seven warehouses |
| | | for 2017 was |
| | | 2,276,416 kWh” |

In the provided examples, users 36 can access their billing and account information by simply asking a question. In response, the data processing center 12 provides easy to understand answers, insights, and other useful information maintained in or otherwise derived from the analytic store 22.

It should also be noted that inquiries and responses do not have to be voice based. In alternative embodiments, the inquiries and responses can also be text based, such as in the form of text messages and/or emails. In either case, the conversation APE 16 and semantic parser 18 are responsible for converting human readable text- based inquiries into machine understandable inquiries and vice-versa with responses.

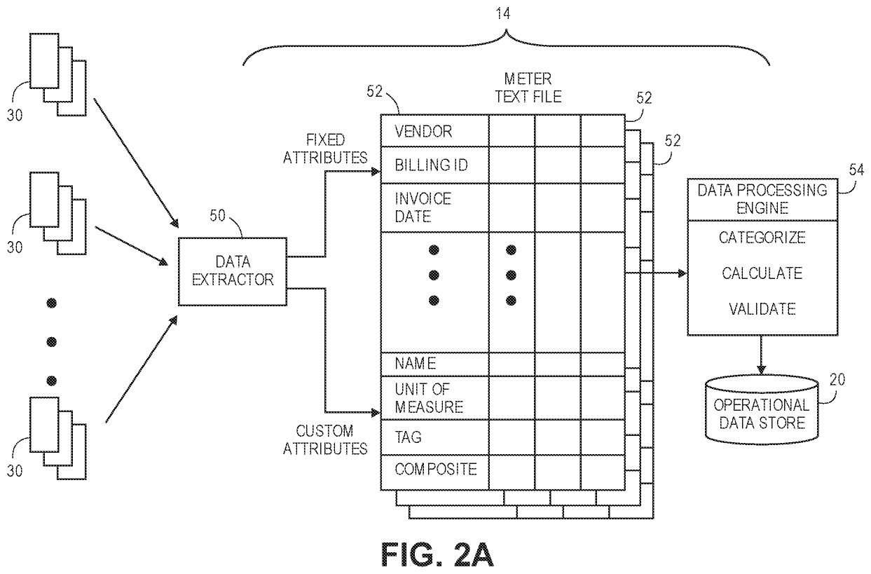

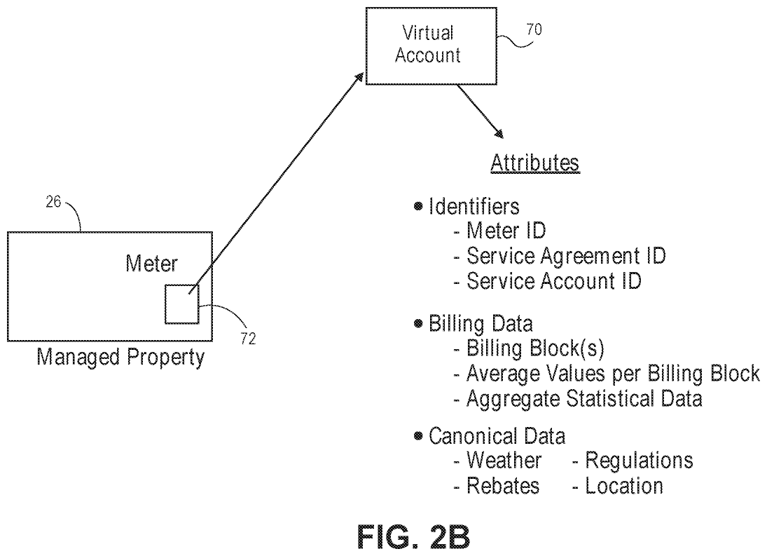

Referring to FIG. 2A, a diagram illustrating operation of the data extraction engine 14 is illustrated.

The data ingestion engine 14 includes a data extractor 50. For each meter detailed in a given bill 30, the data extractor 50 is arranged to tag and assign an attribute to the relevant data extracted from each bill 30. The extracted data is then placed into a dedicated text file 52 for each meter respectively. In a non-exclusive embodiment, the tagged data is arranged in the text file 52 as either a fixed attribute or a custom attribute. Fixed attributes are typically static, meaning they do not ordinarily change from one bill to the next. Examples of fixed attributes include the vendor name, customer name, billing identifier or ID, meter ID, fixed charges, an invoice date (e.g., the same day of the month), due date (e.g., 30 days from invoice date), etc. In contrast, custom attributes tend to be unique to particular bill. Examples of custom attributes include variable charges such as charges for consumption of the utility, usage during peak or off-peak times, etc.

A data processing engine 54 is used to process the information included in the text file 52 for each meter. The data processing involves categorizing the tagged data, performing calculations on the tagged data, and validating the tagged data.

The data processing engine 54 uses the tags assigned to each entry in a text file 52 to categorize the data. In a non-exclusive embodiment, five categories are defined, including (1) usage charges, (2) customer charges, (3) commodity charges, (4) taxes, tariffs and/or fee charges and (5) non-fee usage information. Usage charges are related to the costs for the use of the metered utility. Customer changes are typically fixed fees, such as monthly service charges. Commodity charges tend to charges for equipment, such as a monthly meter fee, a battery storage fee, etc. Tariffs or taxes are changes imposed by government entities.

By way of example, state and federal taxes or regulations for a meter extracted from a bill 30 may be each tagged differently. However, since each can be characterized as a tax or tariff, they each are placed into the same category. Similarly, usage charges, such the rates charged for KW hours, peak usage, etc. Although tagged differently, are each placed in the same usage charges category. As result of this process, all the tagged data entered into the text file 52 for each meter detailed in a bill 30 is categorized into one of the above-listed five categories.

The data processing engine 54 also runs a number of calculations from the text file 52 extracted from the bill for each meter. One such calculation is the computation of a “bill-block” for each meter specified in a bill 30.

A bill-block is defined as a fixed consumption charge for a meter over a defined period of time. For a given meter, a bill 30 typically, but not always, includes a single bill-block. For example if the billing cycle for a meter is defined as the same day between successive months (e.g. August 14 to September 14), and the rate remained the same during this period, then there is only a single bill-block. On the other hand if a rate change went into effect sometime during the billing cycle (e.g., September 1), then the bill includes two bill-blocks. The first bill block is defined as the meter charges at the first rate from August 14 to the 31st, while the second bill block is define as the meter charges for September 1 through the 14th at the second rate. With this latter example, there are two different bill blocks because the bill 30 defines two different charge rates for the meter. If additional rate changes, such as a new tax or tariff going into effect mid-way during the billing cycle, then it is possible for the bill 30 to define additional bill-blocks. Alternatively, if a rebate went into effect during the billing cycle, then yet other bill-blocks may be defined.

For each bill block, the data processing engine 54 calculates or otherwise associates a standard set of values. Exemplary values may include, but are not limited to, (1) days of service, (2) time of use consumption, (3) time of use charges, (3) demand charges, (5) commodity charges, etc. Once the set of standard values are associated with a bill-block, the data processing engine 54 then calculates one or more Average Values for each bill-block using the general equation. For example, a Daily Average Value would be calculated by:

Daily Average Value=(Standard Value±Days of Bill Block Period)

Average values can be calculated or determined over any designated time period, such as hourly, daily, weekly, monthly quarterly, annually, or any other defined time period. The term Average Value should therefore be broadly construed to include or cover any metered or other statistical data pertaining to utility consumption that is averaged over a period of time.

The process of extracting data from bills 30, tagging, the creation of text files 52, categorizing, calculating average values and associating meat and/or canonical data enables the creation of a “virtual account” for each meter. The creation of virtual accounts, in turn, significantly simplifies the task of using the AID engine 24 to formulating responses to utility related natural voice inquiries from users 36, analyzing and deriving insights into the energy usage of one or more of the properties 26, and empowers the platform 10 to effectively offer energy and/or utility related consulting services in a manner previously not possible.

The data processing engine 54 also optionally validates the data in the text files 52. In a non-exclusive embodiment, the data is validated by applying a set of rules to the data and detecting irregularities. For instance, a bill may list a number of sub-total charges and a total amount due. If the tally of the sub-amounts is the same as the total amount, then the billing charges are validated. If the tally is different than the total, then the data is not validated. In another example, the billing cycles from month to month for a customer are analyzed. If there is no overlap, then the billing cycle is considered validated. On the other hand if there is overlap, it likely means the customer is possibly being double-charged for the overlapping dates. In yet another example, a new meter ID may appear on a bill. When data is not validated, it may signify that a query or investigation of some kind may be needed to determine or understand the reason for the irregularity.

Utilities companies tend to be inconsistent in regard to how meters are identified. A given utility company may use different identification schemes from one meter to the next. In some circumstances, a meter may not be assigned an identifier at all. In yet other situations, the identifier for a meter swap (e.g., from a non-smart to a “smart meter) at a managed property 26 may or may not result in an update of the identifier. If a property has multiple meters, they are often inconsistently identified using either a single identifier or multiple identifiers. To make the situation even more complicated, different utility companies use different identification schemes. The creation of a virtual account for each meter helps provide a navigation path through all these inconsistency by providing a consistent view of each physical meter, regardless of the utility, location, property or other circumstances.

Referring to FIG. 2B, an exemplary virtual account 70 for a meter 72 located at a managed property 26 is illustrated. The virtual account 70 has a number of attributes specific to the meter 72, including certain identifiers, billing data and optionally canonical data.

Such identifiers may include a unique meter identifier, a service agreement identifier associated and a service account identifier, both associated with the meter 72.

Billing data attributes may include the number of bill block(s) associated with the meter 72 per billing cycle, the calculated average values per bill-block and aggregate statistical data. By updating the virtual account 70 for each received utility bill, a detailed history of statistical usage data for the meter is created. This data is then available to the AID engine 24 and can be used or relied on for developing responses to natural language inquiries received from users 38, for developing predictive insights into usage of the utility by the managed property 26.

Canonical data may include, but is not limited to, weather, rebate, local regulations, location, and other related information. The virtual account 70 is preferably updated each billing cycle. As bills 30 are received for the meter 72, the virtual account 70 is updated with the new billing block, daily average values, canonical data, etc. As result, each virtual account 70 has a rich history of information for the corresponding meter that is developed over time, including historical data of usage, billing block(s), daily average values, all of which is overlaid with useful canonical data.

The virtual accounts 70 for each of the meters 72 provided at the various properties 26 are stored in the analytic data store 22. With a multitude of virtual accounts 70 and other data in the analytic data store 22, a number of benefits are realized, including providing the ability to respond to utility related inquires via the user-friendly natural voice interface.

Consider an inquiry from an energy manager for a retailer having a large a large number of brick and mortar properties (e.g., Prop 1 through Prop N of FIG. 1) located across the United States. Requesting “What are my energy costs for all my stores in the month of July?” previously was very challenging to answer. As previously discussed, each of the electric bills 30 would like having different billing date cycles, different rates, possible rate changes during the month in question, different tariffs, taxes and/or fees from region to region. Sorting through the bills for each property and deriving the energy costs per store was therefore an arduous chore. With a virtual accounts 70 for each meter located at each of the properties 26, calculating the total energy costs for the month of July is a straight-forward task, involving for example the steps of:

(1) Identifying the virtual account 70 for each meter(s) located at each of the properties respectively.

(2) For each virtual account 70 per store, identifying the number of bill-blocks for the month of July.

(3) For each bill-block per virtual account, calculating the energy consumption from (a) the daily average energy consumption value per store and (b) the number of days in the month of July (i.e., 31 days);

(3) For each store, deriving a total energy consumption amount for the month of July based on the energy consumption calculation for each bill-block associated with each virtual account 70 associated with the property.

(4) Adding up all the calculated total energy consumption amount values for all of the stores.

In the process of creating virtual accounts 70, each detailing bill block(s) and average daily values, the consumption of the utility is essentially reduced to a basic unit of consumption per each meter 72. By breaking down the data extracted from otherwise disparate and inconsistent bills 30 into basic units of consumption, the task of analyzing, deriving insights, and answering utility usage inquiries becomes significantly easier.

Once virtual accounts 70 are created, and billing block(s) and daily average values are calculated, responding to a wide variety of different inquiries becomes a straight-forward task. Inquiries such as (1) What is unit energy cost per hour? or (2) What is my energy cost per square foot?, each become easy calculations to address. With the first question, the average daily value of energy consumption is dived by 24 to provide the cost per hour. With the second, the daily average value is divided by applicable meat data 32 detailing the square footage of the building. It should be understood that these are just a handful of possible inquiries. With a rich set of meat data and a history of bills 30 collected over an extended period of time, along with meat data 32 and other canonical data 34, a wide range of inquiries can be answered.

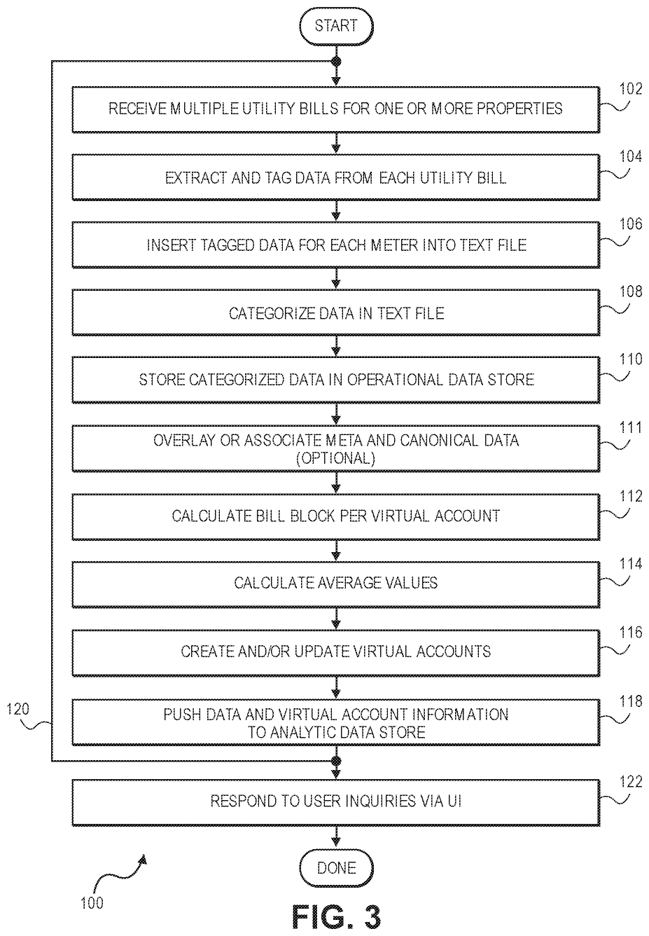

Referring to FIG. 3, a flow diagram 100 illustrating steps for creating virtual accounts 70, pushing data into analytical data store 22 and responding to user inquiries is illustrated.

In the initial step 102, utility bills 30 is/are received for one or more managed properties 26. The utility bills 30 may be in a number of forms, including as PD. Files, accessed via a web site or an on line account, structured electronic feeds, or hard copies. Each utility bill 30 typically provides peak and off peak usage charges for one or more meters, various tariffs, taxes and other charges, etc. Ideally, the utility bills 30 are received on a monthly or some other periodic basis, providing a history of the utility usage for each managed property.

In step 104, data is extracted and tagged from each of the bills 30.

In step 106, the tagged data for each meter is placed in its own text file 52.

In step 108, the tagged data in each text file 52 is parsed and categorized into multiple categories. In a non-exclusive embodiment, the categories include (1) usage charges, (2) customer charges, (3) commodity charges, (4) taxes, tariffs and fee charges and (5) non-fee usage information.

In step 110, the categorized data is stored in the operational data store 20.

In step 111, meter meat data and/or canonical data is optionally over-laid or otherwise associated with the categorized data in the operational data store 20.

In step 112, the bill block for each meter and/or virtual account is specified in the bills 30 is calculated.

In step 114, the various average values for each meter is calculated. As previously noted, these average values can be computed over any defined time period, including minutes, hourly, daily, weekly, monthly annually, etc.

In step 116, the virtual accounts 70 are created for each meter specified in the bills 30. If a virtual account 70 for a meter already exists, the virtual account 70 is updated.

In step 118, the virtual accounts 70 and other data in the operational data store 20 (e.g., meat and canonical data) are pushed into the analytical data store 22. In an optional step, the data pushed into the analytical data store 22 may also be denaturalized.

The arrow 120, following step 118 to step 102, signifies that the above steps 102 through 118 are preferably repeated as bills 30 for the properties 26 are received per each billing cycle. Over the course of numerous billing cycles, a rich history of the utility usage of each meter at the properties 26, along with relevant meat and canonical data, is collected and maintained in the analytic data store 22.

In step 122, the data processing center 12 receives user inquiries via the APE 16 and semantic parser 18. In response, the AID engine 24 accesses the analytical store 22, formulates a response in a machine understandable format, and provides the response to the semantic parser 18 and APE 16. The response is then delivered to the user in a human understandable form. As previously noted, the inquiries and responses are preferably in a natural language format, such as voice, text messages, emails, etc.

With a detailed and rich history of data in the analytical store 22, the AID engine 26 is better able to respond to inquiries from users, derive more accurate and relevant insights, and can offer more informed and intelligent utility based recommendations for improving utility usage, efficiency and for reducing expenditures.

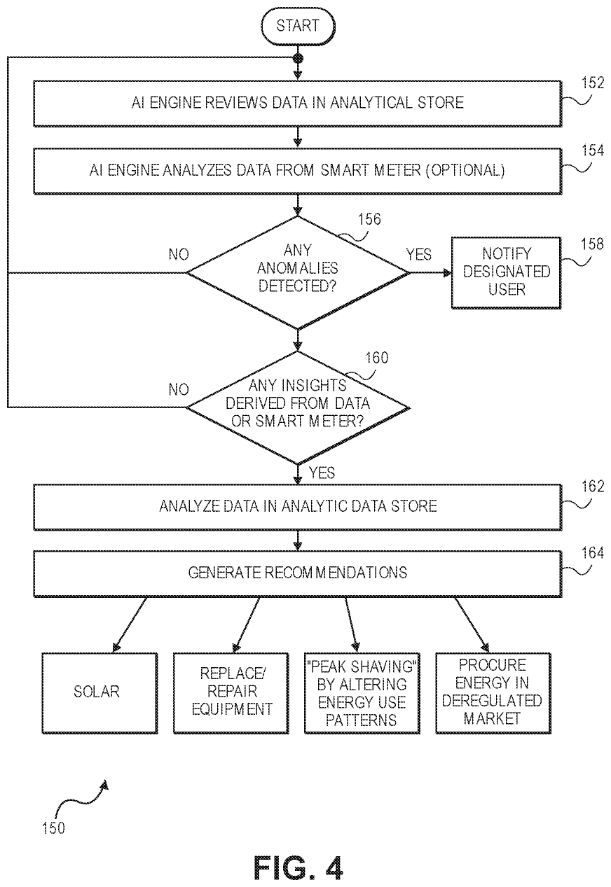

Referring to FIG. 4, a flow diagram 150 illustrating steps performed by platform 10 for notify users 36 of anomalies, deriving insights, performing utility usage analysis and providing recommendations is illustrated.

In step 152, the AID engine 24 reviews the data maintained in the analytical data store 22. In various embodiments, the AID engine 24 can review the analytical data at a fixed time interval (e.g., once per hour, day, week, or month), randomly, whenever records for a given customer is updated, or at any other appropriate time interval.

In optional step 154, the AID engine 24 analyzes data received from a one or more smart meter(s) located at one or more of the managed properties 26. Smart meters have the ability to record electricity consumption and communicate the consumption amount to the utility provider 28. With certain smart meters, they also have the ability to detect, monitor and record the power usage by certain devices located at a managed property 26, such as a HACK system, a refrigerant system, heavy machinery, etc. By monitoring and analyzing the power usage of such equipment, anomalies and insights into energy usage can possibly be determined. Commercially available examples of such smart meters include product offerings by companies such as Bidgely located in Sunnyvale, Calif., a serviced named “Appliance Breakdown” offered by the utility company Hydro Ottawa, or the Neurio Energy Monitor offered by Neurio Technologies, Vancouver, British Columbia, Canada. In various embodiments, the AID engine 24 may analyze data from such smart meters on a fixed interval (e.g., hourly, daily, weekly, monthly, each billing cycle, etc.) or on a continuous or near continuous basis.

In decision 156, the AID engine 24 determines if any anomalies in either the data maintained in the analytic store 22 and/or received from a smart meter is ascertained. If yes, then a designated user is notified in step 158. Anomalies may be detected for a number of different reasons. For instance, a meter reading for one billing cycle may be significantly higher than previous cycles. In which case, the higher consumption may signify an issue, such as a piece of equipment not operating properly or efficiently, windows being left open while the air conditioning is operating, the customer is being overcharged, the incorrect taxes or tariffs are being applied, overlapping charges, etc. By way of example, a sudden and unusually high energy usage during a given timeframe (minutes, hours, days, etc) may indicate that something may be wrong and should be investigated, such as possibly a theft of energy, equipment or appliances malfunctioning or not operating properly, etc. In step 158, the user is notified of any anomalies. In various embodiments, the user may be pro-active notified in any of a number of different ways, such as by text or other electronic messaging, email, letter or other form of written and mailed correspondence, via a web site, by telephone, etc.

In step 160, the AID engine 24 makes a determination of any possible insights that may be derived from the data maintained in the analytic data store 22 and/or from the smart meter. For example, the AID engine 24 may be trained to generate predictive insights form the data in the analytical store 22. For example, a property manager may wish the receive an estimate of the energy usage at the property during the upcoming winter months of January through March. In response, the AID engine 24 access the analytic data store and is able to analyze the virtual account(s) 70 for the meter(s) 72 located at the property. By analyzing past billing data, including billing blocks, calculated average values and aggregate statistical data, the AID engine 24 may be able to develop a predictive model of the utility usage in the defined period of time. In other embodiments, the AID engine 24 may also be capable if improving the predictive model by factoring in other considerations. For example, canonical data such as weather, new regulations, location, etc., may all be factored into the analysis. If the previous winter was very mild, but the upcoming winter is expected to be unusually cold, then the model is updated to take into account the expected harsher weather. Other factors besides canonical data may also be used. If for instance a new, higher efficiency, heating system was installed at the property, then the predictive model may be revised to take into account that less of the utility usage will be required compared to the replaced heating system.

In step 162, the AID engine 24 is used to make intelligent recommendations in response to such insights. In this step, the AID engine 24 typically accesses the analytic data store 22 and develops utility based recommendations. In the case of electricity for example, Such recommendations may include:
Using solar panels for energy generation on site.
Updating, replacing and/or repairing inefficient equipment, such as an old air conditioning system with a more efficient new system or replacing single pane windows with more energy efficient double-pane windows, etc,
“Peak Shaving” by offering recommendations for altering the use of energy-hungry equipment during low peak hours instead of high peak hours.
The procurement of energy from alternative, less expensive, sources in a derogated market.

It is again noted that the embodiments described above are merely illustrative and are not intended to be limiting in any manner. On the contrary, the system and method described above can be used with any type of utility or commodity that is billed on a regular billing cycle. Such alternative embodiments include, but are not limited to, other utilities such as gas or water or other services such as cellular phone or data, cable or satellite television, Internet providers, etc. In each case, the consumer is periodically billed, typically monthly. Using the artificial intelligence system and method as described herein, the data can be extracted from the periodic bills, meat and/or canonical data considered, virtual bills detailing average values and bill blocks generated, and then artificial intelligence applied to provide helpful insights into usage, make usage recommendations, and provide the ability for users to ask questions and receive answers regarding their usage through an easy to use, natural language, interface.

Although only a few embodiments have been described in detail, it should be appreciated that the present application may be implemented in many other forms without departing from the spirit or scope of the disclosure provided herein. Therefore, the present embodiments should be considered illustrative and not restrictive and is not to be limited to the details given herein, but may be modified within the scope and equivalents of the appended claims.

What is claimed is:

1. A method comprising:
receiving one or more utility bills for a meter located at a property;
extracting data from the one or more utility bills;
calculating at least one bill-block for the meter, the bill-block defining a consumption charge for the utility over a period of time;
defining one or more average usage values for the meter, the one or more average usage values derived from the bill-block;
generating a virtual account for the meter, the virtual account including the defined one or more average usage values;
storing the virtual account for the meter in an analytic data store;
receiving an inquiry regarding usage of the utility by the property; and
sending a response to the inquiry, the response generated at least partially derived from the analytic data store storing the virtual account for the meter.

2. The method of claim 1, further comprising:
ascertaining an anomaly in the consumption of the utility from the data extracted from the one or more utility bills; and
notifying a user associated with the property of the anomaly.

3. The method of claim 1, further comprising:
deriving an insight into consumption of the utility from the data extracted from the one or more utility bills for the meter;
analyzing virtual account stored in the analytic data store in response to deriving the insight; and
providing a recommendation to a user associated with the property in response to analyzing virtual account stored in the analytic data.

4. The method of claim 3, wherein the recommendation comprises one or more of the following:
(a) replacing or repairing equipment that uses the utility;
(b) suggesting “peak shaving” by altering usage times of the equipment located at the property;
(c) procuring the utility from different sources in a derogated market; and/or
(d) using solar power to replace or offset usage of the utility.

5. The method of claim 1, wherein the meter located at the property is a smart meter, the method further comprising:
receiving utility consumption data from the smart meter located at the property; and
deriving insights regarding the consumption of the utility at the property from the utility consumption data received from the smart meter.

6. The method of claim 1, further comprising generating a text file for the meter from the data extracted from the one or more utility bills, the text file specifying a plurality of tagged text fields for containing data extracted from the one or more utility bills.

7. The method of claim 6, further comprising:
tagging the data extracted from the one or more utility bills;
inserting the tagged data into the plurality of tagged text fields respectively; and
categorizing the tagged data inserted into the plurality of tagged text fields respectively.

8. The method of claim 7, wherein the tagged data is categorized into one or more of the following categories:
(a) usage charges;
(b) customer charges,
(c) utility charges,
(d) taxes, tariffs and/or fee charges; and
(e) non-fee usage information.

9. The method of claim 1, further comprising associating meat data with the virtual account.

10. The method of claim 1, further comprising associating canonical data with the virtual account.

11. The method of claim 10, wherein the canonical data includes one or more of the following:
(a) weather related data;
(b) data related to the meter;
(c) rebate data;
(d) tariff or tax data;
(e) rate engine data;
(f) meter location data; and/or
(g) data characterizing the building using the meter.

12. The method of claim 1, further comprising storing in an operational data store a text file including the data extracted from the one or more utility bills, meat data associated with the meter, and canonical data.

13. The method of claim 1, further comprising using an Artificial Intelligence (AID) engine arranged to process the data extracted from the one or more utility bills, the processing the data extracted from the one or more utility bills by the AID engine resulting in one or more of the following:
(a) ascertaining anomalies in consumption of the utility as measured by the meter; and/or
(b) deriving insights into the consumption of the utility.

14. The method of claim 13, further comprising storing the data processed by the AID engine into an analytic data store.

15. The method of claim 1, wherein the inquiry is either a voice or a text based inquiry.

16. The method of claim 1, further comprising:
receiving the inquiry in a human understandable form; and
converting the inquiry in the human understandable form into a machine understandable form.

17. The method of claim 1, further comprising:
generating the response in machine understandable form;
converting the response in the machine understandable form into a human understandable form.

18. The method of claim 1, wherein the virtual account for the meter includes one or more of the following attributes:
(a) a meter identifier (ID) associated with the meter;
(b) a service agreement ID associated with usage of the meter;
(c) a service account ID associated with use of the meter;
(d) the at least one bill-block for the meter;
(e) the defined one or more average values per the at least one bill-block for the meter; and/or
(f) canonical data associated with the meter.

19. The method of claim 1, wherein the meter measure of one of the following utilities:
(a) electricity;
(b) water;
(c) gas;
(d) sewage;
(e) waste; and/or
(f) fire protection.

20. The method of claim 1, further comprising:
receiving data from multiple utility bills for multiple meters located at multiple properties respectively;
generating multiple virtual accounts for each of the multiple meters respectively; and
using an artificial intelligence (AID) engine to respond to inquiries related to the utility usage by the multiple properties respectively, the responses generated by the AID engine from the virtual accounts.

21. The method of claim 1, further comprising:
receiving data from multiple utility bills for multiple meters located at multiple properties respectively;
generating multiple virtual accounts for each of the multiple meters respectively; and
using an artificial intelligence (AID) engine to analyze the virtual accounts and to generate insights into usage of the utility.

22. The method of claim 1, further comprising:
receiving data from multiple utility bills for multiple meters located at multiple properties respectively;
generating multiple virtual accounts for each of the multiple meters respectively; and
using an artificial intelligence (AID) engine to analyze the virtual accounts and to generate recommendations for usage of the utility for the multiple properties.

23. A method for generating a virtual bill for a utility meter located at a property, comprising:
receiving one or more utility bills for the meter located at the property;
extracting data from the one or more utility bills;
calculating at least one bill-block for the meter from the data extracted from the one or more utility bills, the bill-block defining a consumption charge for the utility over a period of time;
defining one or more average usage values for the meter, the one or more average usage values derived from the bill-block; and
generating the virtual account for the meter, the virtual account including the defined one or more average usage values.

24. The method of claim 23, wherein generating the virtual account further comprises generating a text file for the meter from the data extracted from the one or more utility bills, the text file specifying a plurality of tagged text fields for containing data extracted from the one or more utility bills.

25. The method of claim 24, further comprising:
tagging the data extracted from the one or more utility bills;
inserting the tagged data into the plurality of tagged text fields respectively; and
categorizing the tagged data inserted into the plurality of tagged text fields respectively.

26. The method of claim 25, wherein the tagged data is categorized into one or more of the following categories:
(a) usage charges;
(b) customer charges,
(c) utility charges,
(d) taxes, tariffs and/or fee charges; and
(e) non-fee usage information.

27. A method, comprising
generating a virtual account for a utility meter located at a property, the virtual account including a plurality of average unit values pertaining to usage of a utility at the property as measure by the utility meter;
deriving one or more insights into the usage of the utility by using an artificial intelligence engine to analyze the virtual account; and
pro actively providing a utility usage recommendation for the property based on the one or more insights into the usage of the utility derived from the artificial intelligence engine analyzing the virtual account.

28. The method of claim 27, wherein deriving the one or more insights further comprises using the artificial intelligence engine to ascertain an anomaly in the consumption of the utility at the property.

29. The method of claim 28, wherein the utility usage recommendation comprises replacing or repairing equipment that uses the utility.

30. The method of claim 28, wherein the utility usage recommendation comprises proposing a “peak shaving” strategy by altering usage of consumption of the utility from times have a higher rate charge to a lower rate charge.

31. The method of claim 28, wherein the utility usage recommendation comprises procuring the utility from different sources in a derogated market.

32. The method of claim 28 wherein the utility is electricity and the utility usage recommendation comprises using solar power to replace or offset usage of the electricity provided by the utility.

33. The method of claim 27, further comprising associating meat data with the virtual account.

34. The method of claim 27, further comprising associating canonical data with the virtual account.

35. The method of claim 27, wherein the canonical data includes one or more of the following:
(a) weather related data;
(b) data related to the meter;
(c) rebate data;
(d) tariff or tax data;
(e) rate engine data;
(f) meter location data; and/or
(g) data characterizing the building using the meter.

36. The method of claim 27, further comprising:
generating a plurality of virtual accounts for a plurality of corresponding utility meters respectively, the plurality of meters located at one or more properties;
each of the virtual accounts including a plurality of average unit values pertaining to usage of a utility as measure by the corresponding utility meter;
deriving one or more insights into the usage of the utility by using an artificial intelligence engine to analyze the plurality of virtual accounts; and
pro actively providing one or more utility usage recommendations for the one or more properties based on the one or more insights into the usage of the utility derived from the artificial intelligence engine analyzing the plurality of virtual accounts.

37. The method of claim 27, further comprising maintaining an operational data store, the operational data store containing a plurality of virtual accounts for a plurality of corresponding utility meters respectively, the plurality of meters located at one or more properties.

38. The method of claim 37, further comprising associating meat data with each of the plurality of virtual accounts maintained in the operational data store respectively.

39. The method of claim 37, further comprising associating canonical data with each of the plurality of virtual accounts maintained in the operational data store respectively.

40. The method of claim 39, wherein the canonical data includes one or more of the following:
(a) weather related data;
(b) data related to the meter;
(c) rebate data;
(d) tariff or tax data;
(e) rate engine data;
(f) meter location data; and/or
(g) data characterizing the building using the meter.

41. The method of claim 27, wherein the virtual account includes one of more of the following:
(b) a service agreement ID associated with usage of the meter;
(c) a service account ID associated with use of the meter;
(d) the at least one bill-block for the meter;
(e) the defined one or more average values per the at least one bill-block for the meter; and/or
(f) canonical data associated with the meter.

42. The method of claim 27, further comprising providing a natural language user interface for interfacing with the artificial intelligence engine, the natural language user interface enabling inquiries and receiving responses regarding usage of the utility at the property.

43. The method of claim 42, wherein the natural language user interface is a voice natural user interface.

44. The method of claim 42, wherein the natural language user interface is a text- based natural user interface.

45. The method of claim 27, further comprising:
receiving a natural language inquiry regarding the usage of the utility at the property;
arranging the artificial intelligence engine to analyze the virtual account maintained in an operational data store in response to receiving the natural language inquiry;
arranging for the artificial intelligence engine to formulate a response to the inquiring after analyzing the virtual account maintained in an operational data store; and
generating natural language response from the response formulated by the artificial intelligence engine.

46. A method for generating a virtual bill for a utility meter located at a property, comprising:
receiving one or more utility bills for the meter located at the property;
calculating at least one bill-block for the meter from a data extracted from the one or more utility bills, the bill-block defining a consumption charge for the utility over a period of time;
defining one or more average usage values for the meter, the one or more average usage values derived from the bill-block; and
generating the virtual account for the meter, the virtual account including:
a meter identifier for the meter;
the bill-block; AND
the defined one or more average usage values.

47. The virtual bill of claim 46, wherein the virtual bill for the meter further comprises a service meter agreement identifier for the meter.

48. The virtual bill of claim 46, wherein the virtual bill for the meter further comprises a service account identifier for the meter.

49. The virtual bill of claim 46, wherein the virtual bill for the meter further comprises canonical data associated with the meter.

50. The virtual bill of claim 49, wherein the canonical data includes one or more of the following:
weather data;
rebate data
regulation data; and/or
location data associated with the meter.
